(19) United States
(12) Patent Application Publication
(10) Pub. No.: US 2008/0080945 A1
(43) Pub. Date: Apr. 3, 2008

(54) Anchor bar and arrangement for reinforcing existing components against punching shears with such anchor bar

(76) Inventors: Peter Bee, Jenins (CH); Camiel de Smet, Tuggen (CH); Jakob Kunz, Grabs (CH); Fritz Muenger, Gotzis (CH); Norbert Randl, Spittal an du Dron (DE)

Correspondence Address: ABELMAN, FRAYNE & SCHWAB, 666 THIRD AVENUE, 10TH FLOOR, NEW YORK, NY, 10017, US

(21) Appl. No.: 11/904,787

(22) Filed: Sep. 27, 2007

(30) Foreign Application Priority Data
Sep. 28, 2006 (DE) 10 2006 000 486.8

(51) Int. Cl. F16B 13/06

(52) U.S. Cl. 411/44

(57) ABSTRACT

An anchor bar includes an anchoring section (16; 26), a threaded section (17; 27), and an intermediate section (18; 28) located between the anchoring section (16; 26) and the threaded section (17; 27) and having an anti-adhesive surface.

### BACKGROUND OF THE INVENTION

1. Field of the Invention

The present invention relates to an anchor bar having an anchoring section and a threaded section. The present invention further relates to an arrangement for reinforcing existing constructional components against punching shears with the anchor bar.

2. Description of the Prior Art

Anchor bars are formed as bar-shaped anchor rods which, e.g., are driven in boreholes filled with a hardenable mass such as, e.g., a mortar, and are preloaded with a preloading element after the start of the bonding process. E.g., U.S. Pat. No. 4,662,795 discloses a rock anchor that can serve an anchor bar. The anchor bar of the U.S. Pat. No. 4,662,795 has anchoring section in the form of a profiled section that extends from a first end, and a threaded section that extends from the second end of the anchor bar and adjoins the anchoring profiled section. The borehole is partially filled with a hardenable mass, and the anchor bar is driven into the borehole with its anchoring section first. After the start of the bonding or hardening process, a preloading nut is screwed onto the threaded section, securing the anchor bar, with the preloading nut being supported against the constructional component via a washer. A region, which is not anchored in the hardenable mass, can be extended as a result of application of the preloading load.

The drawback of the anchor bar of the U.S. Pat. No. 4,662,795 consists in that the anchor bar is not completely embedded in the hardenable mass and, therefore, the non-embedded region of the anchor bar is not precisely guided in the borehole. Therefore, the anchor bar should be massive enough to be able to absorb the load acting thereon. The large material consumption increases manufacturing costs of such anchor bar, and it cannot be economically produced as a mass production part.

In concrete construction, in particular in bridge, industrial, and commercial constructions, often slab floors, which are supported on pillars, and are often very filigree, have a tendency to form punch shears. If the slab floors are underdimensioned with respect to their reinforcement or they become overloaded, e.g., as a result of increase of a load applied thereto, the constructional parts fail, primarily, as a result of flection or caving in. The failure that results from flection can be recognized based on flex cracks. Against that, the failure of a constructional component at a punching shear is sudden, without any advance notice, with the punching shear producing a so-called brittle fracture.

The failure resulting from flection can be overcome in an existing construction with provision in the flection area of an additional reinforcement in form of steel or glass fiber reinforced plastic plates glued onto the affected area. However, a subsequent reinforcement of a constructional component in order to increase the resistance against punching shears presents a problem. Of course, the resistance of a constructional component can be increased by arrangement of a steel construction or by providing an additional layer(s) of concrete. However, such localized measures are often constructively or aesthetically not desirable in light profile constructions or are not possible because of resulting limitations of their use.

German Publication DE 196 20 029 A1 discloses a reinforcing arrangement for a subsequent increase of resistance against punching shears in pillar-supported slab floors. Bores are formed through the floors in the vicinity of the pillars. The reinforcing arrangement includes two parts which are arranged, respectively, on the lower and upper surfaces of the slab floor and are connected with each other by screw means to which a tightening force is applied. The remaining spaces in the boreholes are filled with injection mortar.

The drawback of the arrangement of the above-discussed German publication consists in that the component needs to be accessible from both sides. In case of an upper floor, the space above and below the floor can be used only to a limited extent or cannot be used at all. E.g., if a slab floor of an underground car park, which is covered with earth, should be reinforced, the region above the floor should be freed from earth for using the reinforcing arrangement. In addition, during drilling, the sealing in drilled through which should again be restored with additional costs.

An object of the present invention is a tightenable anchor bar that can be simply and economically produced.

Another object of the invention is an arrangement for a subsequent reinforcement of existing constructional components against punching shears with the inventive anchor bar and which can be easily mounted.

### SUMMARY OF THE INVENTION

These and other objects of the present invention, which will become apparent hereinafter, are achieved by providing an anchor bar having an intermediate section located between the anchoring section and the threaded section and having an anti-adhesive surface.

The anchoring section can have a shaped surface that insures a satisfactory bonding of the anchoring section with the hardened mass. E.g., the anchoring section can be formed by a reinforcement bar section with ribs. The threaded section can have, e.g., a machine thread onto which a tension nut is screwed. The shape of the intermediate section is secondary, as long as the surface prevents bonding of the hardenable mass to the anchor bar in the region of the intermediate section and a preloading force can be applied to the anchor bar.

With an intermediate section having a non-adhesive or anti-adhesive section, the anchor bar can be almost completely embedded in the hardened mass in the borehole. Thereby, high anchoring values can be achieved despite the fact that the anchor bar is subjected to a tightening or preloading load. Further, an intermediate section with an anti-adhesive surface insures a satisfactory driving-in of the anchor bar in a deep borehole. In addition, the inventive anchor bar can be economically produced, as essentially the maximal applicable tightening force is a primary parameter used in dimensioning of the anchor bar. In case when the threaded section projects from the constructional component, the intermediate section is formed of stainless steel.

Preferably, the intermediate section is provided with a sleeve that surrounds the anchor bar. The sleeve, e.g., can be formed of a plastic material and have an inner diameter that is smaller than the outer diameter of the anchor bar in the region of the intermediate section. The sleeve is pushed, e.g., over the anchor bar and, if necessary, is displaced thereon or is cut to length in order to be able to apply different preloading forces to the anchor bar or in order to be able to achieve predetermined anchoring values with the anchor bar. The hardenable mass, e.g., can adhere to the outer surface of the sleeve, however, bonding of the hardenable mass to the intermediate section is prevented by the sleeve. Alternatively, the outer surface of the sleeve can be anti-adhesive or non-adhesive, preventing bonding of the hardenable mass with the sleeve. The thread of the threaded section can directly adjoin the anchoring section in this case, with the axial extension of the sleeve, which is pushed over the anchor bar, defining the intermediate section.

According to one embodiment of the present invention, the intermediate section has a coating that prevents bonding of the hardenable mass to the anchor bar in the region of the intermediate section. The coating can be formed by a layer of plastic material sprayed onto the anchor bar, by lacquer (coating), or by a plastic film. In this case likewise, the thread of the threaded section can directly adjoin the anchoring section, with the axial extent of the coating, which was applied to the anchor bar, defining the intermediate section of the anchor bar.

The inventive arrangement for reinforcing existing constructional components against punching shears includes an anchoring section, a threaded section, and an intermediate section located between the anchoring section and the threaded section and having an anti-adhesive surface. The anchor bar is inserted in borehole extending at an angle to the surface of a constructional component and filled with a hardenable mass and is preloaded with preloading means in the borehole.

The borehole is drilled in the direction toward the pillar, preferably, up to the level of the upper reinforcement, whereby after hardening of the hardenable mass, the anchor bar, which is anchored in the borehole, bridges the punching shear cracks at an angle thereto. The anchor bar is preloaded, e.g., by preloading means in form of a tension nut that is screwed onto the threaded section and is supported against a constructional component that forms the support means, via a washer. The resistance of a subsequently reinforced constructional component against punching shears can be increased by more than 50% by the inventive arrangement. The mounting of the arrangement is carried out only from one side of the constructional component, and the original volume of the construction remains unchanged even after mounting of the reinforcement. Penetration through the reinforced component is not necessary, which enables an economical mounting even with sealed constructional components, e.g., such as ceilings of the underground car parks or roof constructions.

The support means includes advantageously a two-part washer having a part with a convex receptacle and a part with a concave projection complementary to the convex receptacle. With such support means, any deviation of alignment of separate parts of the arrangement with the constructional component can be compensated.

Advantageously, the angle, at which the borehole extends to the surface of the constructional components, amounts to from 30° to 60°. Such an angle insures bridging of punching shear cracks in the constructional component. Advantageously, this angle amounts to from 40° to 50°.

Advantageously, the anchor bar is provided with at least one centering element. The centering element is formed, e.g., as an elastic annular section the radially outer extension of which is greater than the inner diameter of a conventionally used borehole, and the inner diameter of which is slightly smaller than the outer diameter of the anchor bar. The at least one centering element ensures a complete, uniform arrangement of the anchor bar in the borehole filled with a hardenable material. Preferably, the at least one centering element has through-openings for the hardenable mass and through which the displaced mass rises toward the borehole mouth when the anchor bar is being driven in the borehole. In addition, a further centering element in form of a sealing element can be provided adjacent to the borehole mouth. Such a centering element prevents exit of the displaced hardenable mass from the borehole, preventing soiling of the working region around the borehole with the hardenable mass. At overhead works, the at least one centering element serves for retaining the anchor bar from falling out of the borehole during the bonding process of the hardenable mass. Advantageously, several, spaced from each other, centering elements are provided on the anchor bar. The centering elements are provided, e.g., on the anchoring section and/or threaded section.

According to an advantageous embodiment of the present invention, the borehole has a recess arranged centrally relative to the borehole and opening toward the surface of the constructional component. In the mounted condition of the anchor bar, the recess receives the preloading means and essentially the section of the anchor bar projecting from the borehole. The preloading mechanism is sunk in the constructional component. As support means for the preloading element a conventional annular washer is provided. With this arrangement, an advantageous introduction of the preloading forces into a constructional component occurs.

Advantageously, a pot-shaped reinforcing element with a through-opening for the anchor rod is arranged in the recess. The shape of the reinforcing element is complementary to the shape of the recess. The reinforcing element is formed, e.g., of metal and is supported against the wall of the recess. Thereby, the pressure forces, which act in this region of the constructional component, can be absorbed by the constructional component essentially within the range of the original values, despite the presence of the recess.

Advantageously, the recess is filled with a filling mass, so that the subsequently arranged reinforcement cannot be recognized or can hardly be recognized. Furthermore, the behavior of the inventive arrangement is noticeably improved in case of fire due to the filling mass. The filling mass is a hardenable mass in form of a fire protection mass or mortar. Alternatively, a fire protection foam can be used as a filling mass.

According to another advantageous embodiment of the present invention, a bevel washer is provided, with the inclination angle of the bevel to the axis of the opening for the anchor bar corresponding to the angle at which the borehole extends to the surface of the constructional component. A preloading force, which is applied from the preloading means to the anchor bar, is introduced into the washer, which serves as support means, and through the inclined surface of the washer which abuts the constructional component, into the constructional component.

Advantageously, a sealing disc or washer is provided which is engaged by the preloading means. Thereby, upon preloading of the anchor bar, the borehole and, thus, a portion of the anchor bar located in the borehole are sealed from outside. Advantageously, the sealing washer has a vertical channel that makes possible to fill the region of the borehole mouth with a hardenable sealing mass after the preloading process. At that, an annular gap between the anchor bar and the support means or the preloading means becomes closed with the injected mass, so that a clearance-free connection is provided.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a side view of a first embodiment of an anchor bar according to the present invention:

FIG. 2 a side view of a second embodiment of an anchor bar according to the present invention:

FIG. 3 a schematic cross-sectional view of two embodiments of an arrangements according to the present invention mounted on a slab FIG. 4 a cross-sectional view along line IV-IV in FIG. 3;

FIG. 5 a cross-sectional view along line V-V in FIG. 3; and

FIG. 6 a cross-sectional view of a reinforcing element.

In the drawings, the same elements are designated basically with the same referenced numerals.

### DETAILED DESCRIPTION OF THE PREFERRED EMBODIMENTS

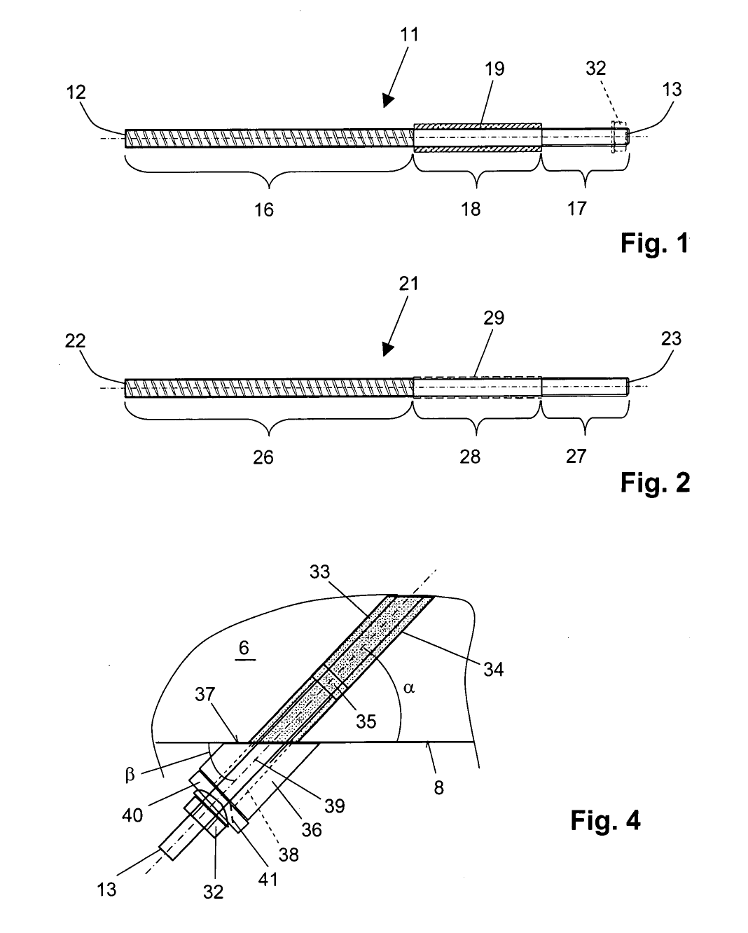

An anchor bar 11 according to the present invention, which is shown in FIG. 1, has an anchoring section 16 extending from the first end 12 of the anchor bar 11, a threaded section 17 extending from the second end 13 of the anchor bar 11, and an intermediate section 18 having an anti-adhesive outer surface and located between the anchoring section 16 and the threaded section 17. The intermediate section 18 is provided with a sleeve 19 which surrounds the anchor bar 11 and is formed of a plastic material, e.g., with anti-adhesive properties. The anchoring section 16 is formed of a ripped reinforcing rod. The threaded section 17 has an outer thread for a tension nut that serves as preloading means 14. In this embodiment, the intermediate section 18 has a smooth surface on which the sleeve 19 is displaceably secured.

The anchor bar 21, which is shown in FIG. 2, has, as the anchor bar 11, an anchoring section 26 extending from the first end 22 of the anchor bar 21, a threaded section 27 extending from the second end 23 of the anchor bar 21, and an intermediate section 28 having an anti-adhesive outer surface and located between the anchoring section 26 and the threaded section 27. In distinction from the anchor bar 11, a coating 29 is used for forming a non-adhesive outer surface of the intermediate section 28.

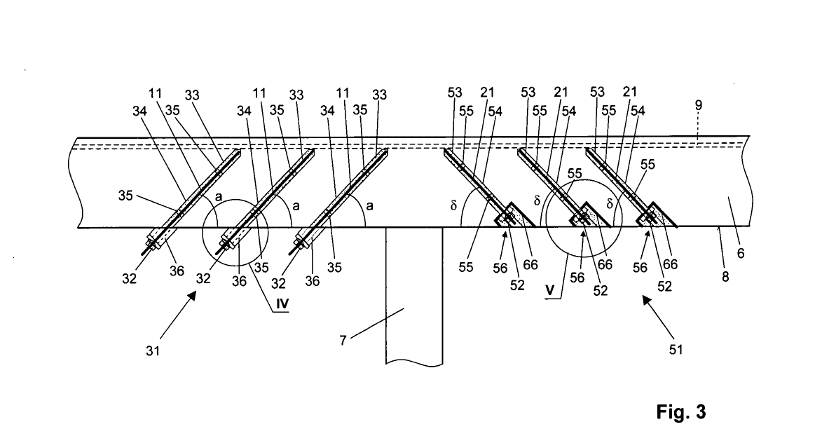

FIG. 3 shows two embodiments of arrangements 31 and according to the present invention for reinforcing a slab floor 6, which is supported on pillars 7, against punching shears and which include, respectively, the anchor bars 11 and 21 that have, respectively, the anchoring section 16 or 26, the threaded section 17 or 27, and an intermediate section 18 or 28 with a non-adhesive outer surface and located between the anchoring section 16, 26 and the threaded sections 17, 27, respectively. In both embodiments, the anchor bars 11 and 21 are arranged at an angle to the surface 8 of the slab floor 6, are inserted in boreholes 34 or 54, respectively, which are filled with a hardenable mass 33, 53, and are preloaded with preload means 32, 52, respectively. For proper aligning of the anchor bars 11 or 21 in the boreholes 34 or 54, each anchor bar 11 or 21 has two centering elements 35 or 55. During the bonding period of the hardenable mass 33 or 53, the centering elements 35 or 55 hold the anchor bars 11 or 21 in a proper position in the boreholes 34 or 54 and secure the anchor bars 11 or 21 from sliding out from the boreholes 34 or 54.

With the arrangement 31 according to the first embodiment, as shown with reference to FIG. 3, to the left of the pillar 7, and in detail in FIG. 4, first, boreholes 34 are formed up to the level of an upper reinforcement 9 of the slab floor 6 and at an angle α of about 45° to the outer surface 8 of the slab floor 6 and toward the pillar 7. Then, each borehole 34 is filled with mortar form a hardenable mass 33. Advantageously, a hold-up plug is used that prevents to a large extent undesirable air pockets in the hardenable mass 33 during the filling process. The anchor bar 11 is inserted in the borehole 34 filled with the hardenable mass 33. A bevel washer 36 is placed over the free end 13 of the anchor bar 11. The angle β of the bevel 37 of the washer 36 to the axis 39 of the through-opening 38 for the anchor bar 11 corresponds to the angle α of the borehole 34 to the surface 8 of the slab floor. There is further provided a sealing washer 40 that is secured with the preloading means 32 and that is provided with a filling channel 44. Through the filling channel 41, a sealing mass is introduced. The sealing mass closes an eventual leakiness in this region.

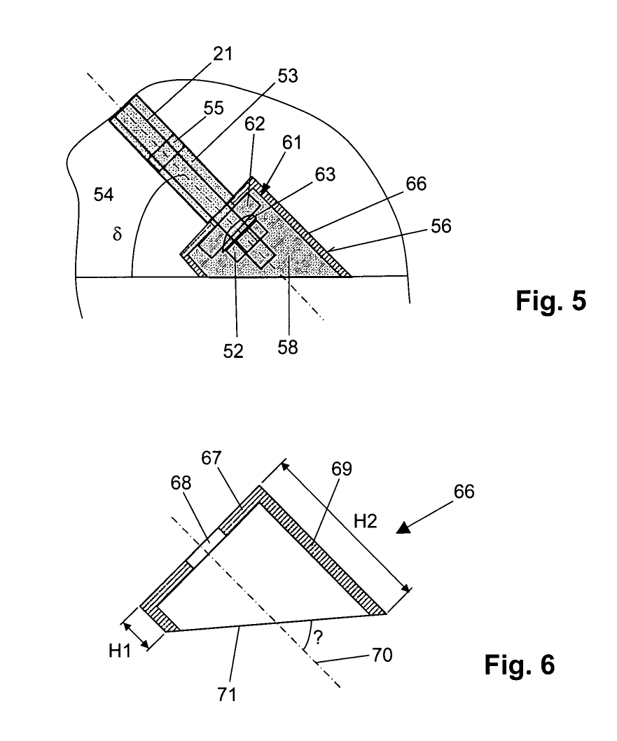

With the arrangement 51 according to the second embodiment, as shown with reference to FIG. 3, to the right of the pillar 7, and in detail in FIGS. 5-6, first, boreholes 54 are formed up to the level of an upper reinforcement 9 of the slab floor 6 and at an angle β of about 50° to the outer surface 8 of the slab floor 6 and toward the pillar 7. Then, at each borehole 54 and centrally thereto, a recess 56, which opens toward the outer surface 8 of the slab floor 6, is formed, e.g., with an annular core bit. Then, each borehole 54 is filled with a mortar from hardenable mass 53, and a pot-shaped reinforcing element 66 is placed in the recess 56. Then or, alternatively, before placement of the reinforcing element 66 in the recess 56, the anchor bar is inserted in the borehole 54. Over the free end 23 of the anchor bar 21, a two-part washer 61, which serves as a support element, is mounted and is secured with the preloading means 52. The washer 61 has a first part 62 with a convex receptacle and a second part 63 with a concave projection complementary to the convex receptacle. The first part 62 of the washer 61 can be formed, e.g., as a sealing washer. The recess 56 is then filled with a fireproof mortar in form of mass 58.

A pot-shaped reinforcing element 66, a cross-section of which is shown in FIG. 6 has a shape substantially complementary to the recess 56. In the plan view, the circular reinforcing element 66 has a bottom section 67 with a through-opening 68 for the anchor bar 21 and a wall section 69 the height of which varies. The minimal height H1 and the maximal height H2 are so selected that the reinforcing element 66 does not extend above the outer surface 8 of the slab floor 6 when set in the recess 56. The angle γ of the bevel 71 to the axis 70 of the through-opening 68 for the anchor bar 21 corresponds to the angle γ of the borehole 54 to the surface 8 of the slab floor 6.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. An anchor bar, comprising an anchoring section (16; 26); a threaded section (17; 27); and an intermediate section (18; 28) located between the anchoring section (16; 26) and the threaded section (17; 27) and having an anti-adhesive surface.

2. An anchor bar according to claim 1, wherein the intermediate section (18) is provided with a sleeve (19) that surrounds the anchor bar (11).

3. An anchor bar according to claim 1, wherein the intermediate section (28) has a coating (29).

4. An arrangement for reinforcing constructional components against punching shears, comprising an anchor bar (11; 21) having an anchoring section (16; 26); a threaded section (17; 27); and an intermediate section (18; 28) located between the anchoring section (16; 26) and the threaded section (17; 27) and having an anti-adhesive surface, the anchor bar being insertable in borehole (34; 54) extending at an angle (α; β) to surface (8) of a constructional component (6) and filled with a hardenable mass (33; 53); and
preloading means (32; 52) for preloading the anchor bar (11; 21) in the borehole (34; 54).

5. An arrangement according to claim 4, wherein the angle (α) of borehole (34; 54) to the surface (8) of the constructional component (6) amounts to from 30° to 60°.

6. An arrangement according to claim 4, wherein the anchor bar (11; 21) has at least one centering element (35; 55).

7. An arrangement according to claim 4, wherein the borehole (54) has a recess (56) arranged centrally relative to the borehole (54) and opening toward the surface (8) of the constructional component (6).

8. An arrangement according to claim 7, further comprising a pot-shaped reinforcing element (66) located in the recess (56) and having an opening (68) for the anchor bar (21) and a shape complementary to a shape of the recess (56).

9. An arrangement according to claim 7, wherein the recess (56) is filled with a filling mass (58).

10. An arrangement according to claim 4, comprising a bevel washer (36) having an angle (β) of the bevel (37) to an axis (39) of a washer opening (38) for the anchor bar (11) corresponds to the angle (α) at which the borehole (34) extends to the surface (8) of the constructional component (6).

11. An arrangement according to claim 4, further comprising a sealing washer (40) engageable by the preloading means (32).

12. An arrangement according to claim 11, wherein the washer has a filling channel (41).
